(19) United States
(12) Patent Application Publication
(10) Pub. No.: US 2011/0048814 A1
(43) Pub. Date: Mar. 3, 2011

(54) Final Drive Assembly

(75) Inventor: Robert William Thompson, Frimley Green (GB)

(73) Assignee: QINETIQ LIMITED

(21) Appl. No.: 12/871,599

(22) Filed: Aug. 30, 2010

(30) Foreign Application Priority Data
Sep. 3, 2009 (GB) 0915306.5

(51) Int. Cl. B62D 11/04; F16H 57/08; B62D 11/00; B62D 55/00

(52) U.S. Cl. 180/6.7; 475/331

(57) ABSTRACT

A final drive assembly, particularly for a skid steered vehicle, comprises a planetary gear reduction mechanism of which the input is through the sun gear 38 and the output is through the planet carrier 43. The sun gear is formed on a hollow shaft 26 which is driven by a coupling shaft 18a extending coaxially within it. These shafts are coupled through a coupling member 31 splined to each shaft, the larger diameter coupling 32 with the hollow shaft 26 being a crowned spline coupling to accommodate angular misalignment between the shafts.

### BACKGROUND OF THE INVENTION

Field of the Invention

The present invention relates to final drive assemblies and more particularly (though not exclusively) to final drives for tracked or wheeled skid steered vehicles.

### SUMMARY OF THE INVENTION

The present invention as is described hereinafter in terms of its application within an overall drive configuration for a battle tank, bulldozer or other skid steered vehicle of the kind described in WO-02/083483 or WO-2006/021745, although it may be found more generally useful for vehicular applications.

The invention resides in various aspects of the assembly of which a preferred embodiment is described hereinafter and of which specific objects include a compact assembly with minimal intrusion within the vehicle hull, with provision to accommodate some misalignment with, and disengagement from, the inboard transmission. In accordance with one such aspect a final drive assembly comprises a planetary gear reduction mechanism of which the input is through the sun gear and the output is through the planet carrier, the sun gear turning with a first, hollow shaft which is driven through a second shaft extending coaxially within the first shaft, and the first and second shafts being coupled through a coupling member splined to each said shaft.

Preferably the coupling member and first shaft are coupled through a crowned spline coupling having a diameter substantially greater that the splined coupling between the coupling member and second shaft.

A mechanism may be provided for displacing the second shaft axially with respect to the first shaft while the splined couplings of the coupling member to each said shaft are maintained.

The first shaft is preferably rotationally supported by bearings located outboard of the sun gear in the sense of the intended mounting of the assembly to a vehicle, and such bearings may act between the first shaft and a third shaft which is arranged to be driven by the planet carrier.

The assembly of planet carrier and planet gears preferably floats between the sun gear and annulus of the planetary gear reduction mechanism and the planet carrier is preferably single sided and supports the planet gears in cantilever fashion. Its output is preferably through a crowned spline coupling.

The assembly may be combined with a track drive sprocket for a tracked vehicle arranged to be driven through said assembly, and/or with a brake arranged to act on the first shaft.

In another aspect the invention resides in a drive configuration for a skid steered vehicle comprising: a pair of propulsion motors coupled through respective transmissions to drive a respective drive member (such as a track drive sprocket in the case of a tracked vehicle or a wheel hub in the case of a wheeled vehicle) at a respective side of the vehicle; at least one steer motor coupled to a differential gear mechanism coupled between said propulsion motors to selectively impose a speed difference between said drive members; and each transmission comprising a respective final drive assembly or combination as defined above associated with the respective drive member.

### DESCRIPTION OF THE SEVERAL FIGURES

These and other aspects and features of the present invention will now be more particularly described, by way of example, with reference to the accompanying drawings, in which:

FIG. 1 is a diagrammatic illustration of a drive configuration for a skid steered vehicle in which the invention may be embodied;

FIG. 2 illustrates schematically a mechanism for the controlled differential of the configuration of FIG. 1;

FIG. 3 is an axial cross-section through a preferred form of a final drive assembly according to the invention for incorporation in the drive configuration of FIG. 1; and

FIG. 4 illustrates the typical form of a crowned spline.

### DESCRIPTION OF THE INVENTION,

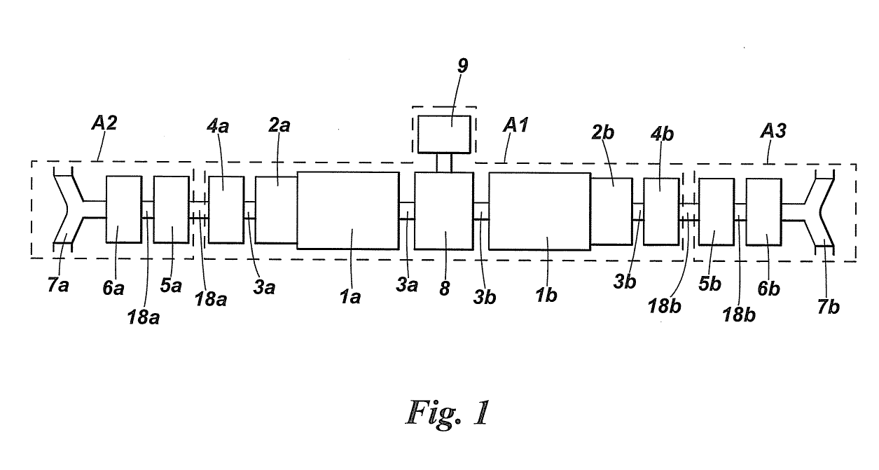

FIG. 1 illustrates diagrammatically one form of vehicular drive configuration with which final drive assemblies in accordance with the present invention may be found particularly useful, being a track drive arrangement for a skid steered vehicle according to WO-02/083483 or WO-2006/021745. In this Figure a transverse drive arrangement comprises two electric propulsion motors 1a and 1b with associated gear change units 2a and 2b turning drive shafts 3a and 3b respectively. Outbound of these units the transmission includes in each case a gear reduction stage 4a, 4b, a brake 5a, 5b and a final drive gear reduction 6a, 6b, leading to respective track drive sprockets 7a and 7b at opposite sides of the vehicle. Inboard the motors 1a, 1b are coupled through the shafts 3a, 3b to opposite sides of a controlled differential device 8 having an input from one or more electric steer motors 9.

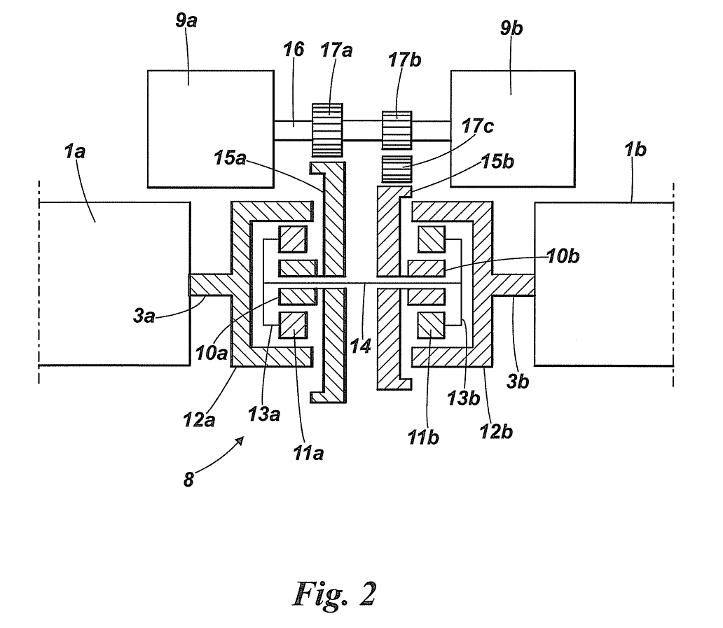

The mechanism of one suitable form of differential 8 is illustrated schematically in FIG. 2. It comprises an opposed pair of planetary gear sets each comprising a sun gear 10a, 10b, planet gears 11a, 11b and an annulus or ring gear 12, 12b, with the planet carriers 13a, 13b of each set interconnected by a cross shaft 14 passing through the sun gears. The annuli 12a, 12b are coupled to the respective adjacent drive shafts 3a, 3b and the sun gears 10a, 10b are fast with respective input gears 15a, 15b which can be driven when required in this case by a coupled pair of steer motors 9a, 9b. The steer motors are in this respect each coupled to a shaft 16 carrying a pinion 17a meshing with gear 15a, and a pinion 17b meshing through an idler gear 17c with gear 15b, so that the direction of rotation of the gear 15b in response to rotation of the shaft 16 is reversed as compared to the direction of rotation of the gear 15a.

During straight running of the vehicle the steer motors 9a, 9b are energised to hold the shaft 16 stationary, so the input gears 15a, 15b and sun gears 10a, 10b are likewise held stationary. Energising the propulsion motors 1a, 1b to drive the sprockets 7a, 7b in this condition also rotates the annuli 12a, 12b to cause the planet gears 11a, 11b to revolve about the sun gears 10a, 10b. Due to their connection by the shaft 14 the two planet carriers 13a, 13b must rotate at the same speed, also equalising the speeds of the two annuli 12a, 12b and the two connected shafts 3a, 3b and related transmission trains in this condition. The actual power distribution between the two transmissions will be determined by the torque required to drive the respective sprockets 7a, 7b with torque being transferred through the controlled differential 8 from one side to the other as required e.g. in respect to changing ground conditions.

To turn the vehicle in one sense while being propelled by the motors 1a, 1b as above the steer motors 9a, 9b are energised to rotate the shaft 16 in a corresponding sense, thus causing the input gears 15a, 15b and their respective sun gears 10a, 10b to rotate in mutually opposite senses. The effect, since the two planet carriers 13a, 13b must always turn together, is to increase the rate of rotation of the individual planet gears 11a, or 11b in that set for which the sun gear 10a or 10b is turning in the opposite sense to the respective annulus 12a or 12b, and to decrease the rate of rotation of the individual planet gears 11a or 11b in that set for which the sun gear 10a or 10b is turning in the same sense as the respective annulus 12a or 12b. This in turn causes the annuli 12a, 12b and respective connected transmissions to the sprockets 7a, 7b to run at different speeds thus turning the vehicle in the required sense, while power from the slower running transmission is mechanically regenerated to the faster running transmission through the controlled differential 8. To turn the vehicle in the opposite sense the steer motors 9a, 9b are energised to rotate the shaft 16 in the opposite sense and so forth, and it will be appreciated that for a given forward speed of the vehicle the turning radius in either sense will depend on the speed at which the steer motors are operated—the faster the steer motors the tighter the turn. In the limit, with zero forward speed the vehicle can be made to perform a neutral turn—i.e. “turning on the spot”—by driving the two transmissions in opposite directions through the differential 8.

In a functionally equivalent arrangement one of the sun gears 10a or 10b can be permanently locked in place and a single gear train used from the shaft 16 to turn the other sun gear as required.

In practice the propulsion motors 1a, 1b, gear change units 2a, 2b, gear reduction stages 4a, 4b, controlled differential 8 and steer motor(s) 9 of FIG. 1 are integrated together in a first major assembly A1 centrally of the vehicle while the brakes 5a, 5b, final drives 6a, 6b and track drive sprockets 7a, 7b are integrated together in separate assemblies A2 and A3 to each side of the vehicle linked to the central assembly through respective coupling shafts 18a, and 18b. In an alternative embodiment a brake acting on the transmission could instead be incorporated in the assembly A1.

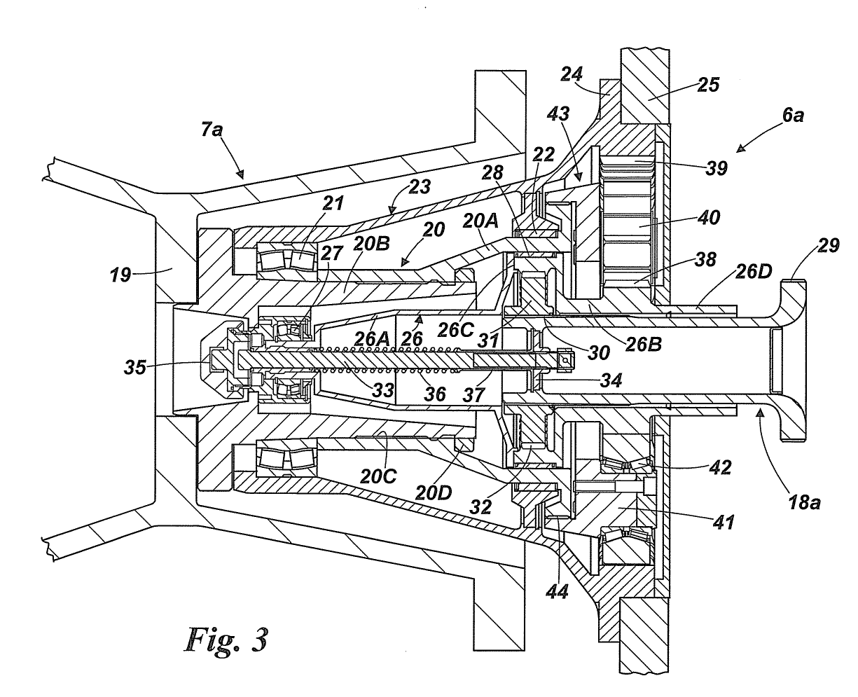

Turning to FIG. 3 this illustrates schematically the main components of the final drive 6a and track drive sprocket 7a in the left hand assembly A2 as viewed in FIG. 1, the corresponding components in the right hand assembly A3 being identical in mirror image.

The track drive sprocket 7a is attached by bolts (not shown) through a flange 19 to a hollow output shaft 20 which is formed in two parts 20A and 20B splined together at 20C and locked by a ring 20D. The shaft 20 is rotationally supported by a pair of bearings 21 and 22 in a fixed casing 23 which has a mounting flange 24 by which it is attached by bolts (not shown) to a side plate 25 of the vehicle hull. The bearing 21 is a spherical roller bearing which axially locates the shaft 20 and is positioned at approximately the centre line of the track to minimise any moment loads on the shaft 20 and inner bearing 22, (the flange 19 of the track drive sprocket itself being offset from the centre line). The bearing 22 is a needle roller bearing and supports any moment loads which are seen at the sprocket 7a; it can also permit some axial movement to accommodate differential thermal expansion and cumulative tolerances. Within the output shaft 20 a hollow input shaft 26 is rotationally supported by a pair of bearings 27 and 28, the shaft 26 being formed in two parts 26A and 26B attached together at 26C by bolts (not shown). Bearing 27 is a spherical roller bearing carried from the output shaft 20 which axially locates the shaft 26 and bearing 28 is a needle roller bearing between the shafts 20 and 26 which can permit some axial movement to accommodate differential thermal expansion and cumulative tolerances. The bearings 27 and 28 are well spaced to provide good support to the sun gear 38 and components of the brake assembly 5a which are located inboard of the bearings.

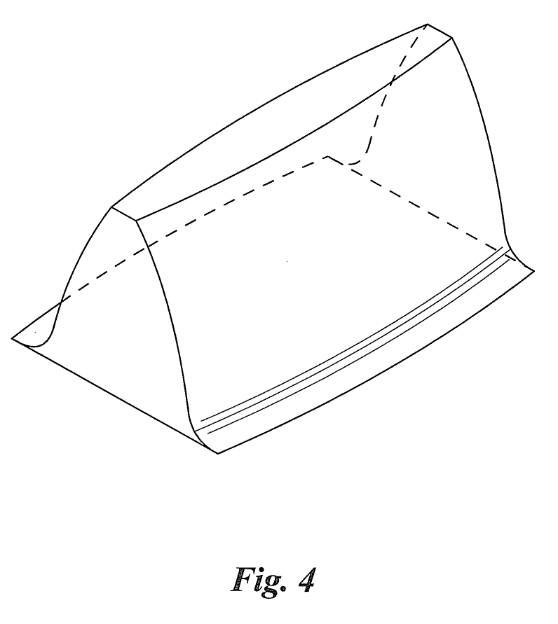

The input shaft 26 is arranged to be driven by the coupling shaft 18a from the central assembly Al of the drive arrangement, the shaft 18a extending with clearance through the brake assembly 5a and coaxially within the shaft 26. In this respect the shaft 18a is splined at its inboard end as at 29 to the output component (not shown) of the gear reduction stage 4a. This output component may be for example the respective gear reduction stage planet carrier in the case of an assembly of the kind shown in FIG. 3 of WO-2006/021745 or the coupling member in the case of an assembly of the kind shown in FIG. 3 of copending U.S. patent application Ser. No. 12/821402. At its outboard end the shaft 18a is splined as at 30 to a coupling member 31, through parallel external and internal spline sets on these components. The coupling member 31 is also splined as at 32 to the input shaft 26. The external splines on this coupling member, which mate with (parallel) internal splines on the input shaft, are crowned splines, that is to say the flanks of the teeth are modified as compared to the usual parallel form and are convex in the lengthwise direction. The typical form of a crowned spline is shown in FIG. 4. By virtue of such crowning some angular misalignment between the shafts 18a and 26, typically up to 1°, can be accommodated without the splines jamming as the assembly rotates. This coupling can therefore compensate for some inaccuracies in the mounting of the central assembly and/or final drive assembly in the vehicle. The bolted joint 26C of input shaft 25 outboard of the splined coupling 32 allows assembly of the components and cutting of the internal spline teeth on that shaft.

It is observed that the crowned spline coupling 32 between the coupling member 31 and input shaft 26 is of a larger diameter than the parallel-to-parallel splined coupling 30 between the coupling shaft 18a and coupling member 31. It can therefore accommodate more and/or larger teeth than the inner coupling. The couplings 30 and 32 can therefore be of similar torque transmitting capacity despite the reduced contact area between individual internal and external spline teeth in the coupling 32 due to the crowning.

Provision is also made for withdrawing the coupling shaft 18a from the central assembly A1 after assembly so that the central assembly can be lifted out of the vehicle if required, for example for maintenance purposes. To this end the withdrawal mechanism comprises a screw 33 mounted to the shaft 26 and threaded through a nut 34 captive in the shaft 18a. The screw 33 is accessible, for winding using a standard socket wench or the like, after removal of a protective cap 35, to draw the shaft 18a to the left as viewed in FIG. 3. This mechanism normally rotates as a whole with the shafts 18a and 26 so eliminates the need for a thrust bearing. The external splines on the shaft 18a which mate with the coupling member 31 at 30 are extended in the lengthwise direction as seen in the Figure so that the shaft can be withdrawn from the assembly A1 without disengaging from its coupling with the coupling member. A compression spring 36 is trapped between an abutment in the end of the shaft 26 and a tube 37 which abuts the nut 24, and urges the shaft 18a to the right (as viewed) to the extent permitted by the engagement of the nut 34 with the screw 33. Winding the screw to withdraw the shaft 18a compresses the spring 36 further. If, upon winding the screw in the opposite direction to re-engage the shaft 18a with the assembly A1, the splines on the relevant output component from that assembly are not correctly aligned with the splines 29 on the shaft 18a, the shaft will be blocked from rightward movement and winding the screw 33 will instead cause the latter to protrude to the left from the end of the shaft 26. As soon as the output component is turned by the transmission to align its splines with the splines 29, however, the shaft 18a and screw 33 will shift to the right under the action of the spring 33 and the shaft will be re-engaged with the assembly A1.

The sun gear 38 of a planetary gear reduction mechanism is formed on the input shaft 26 and the annulus or ring gear 39 of this mechanism is formed on the interior of the fixed casing 23. Between these gears revolve a set of planet gears 40, borne on pins 41 with taper roller bearings 42 in a planet carrier 43. This planetary gear mechanism is the largest diameter component of the final drive assembly and is mounted approximately on the same plane as the vehicle hull side plate 25 so that it does not have to be accommodated within the envelope of the track drive sprocket 7a. All of the other final drive components, including the bearings 21, 22, 27 and 28, are located outboard of the planetary mechanism and do not occupy space within the vehicle hull.

The assembly of planet carrier 43 and planet gears 40 “floats” between the sun gear 38 and annulus 39 to maximise load sharing between the planet gears. Being of relatively large diameter the gears in the planetary mechanism are of relatively narrow face width, as the larger the diameter the less tolerant is this type of mechanism of any misalignments which might otherwise cause the gears to fail prematurely. The planet carrier 43 is single sided, meaning that the pins 41 are cantilevered and there is no additional structure linking two sides of the carrier, so more space is available for planet gears. Typically there may be up to six planet gears 40 to maximise load carrying capacity. The illustrated carrier 43 is a relatively heavy and stiff component suited to high load applications. Alternatively, for lower load applications the planet carrier may be of a light weight design which allows some flexibility and enhances load sharing between all planet gears, in which case self aligning planet gear bearings would be used in place of the taper bearing set 42. In any event, the single sided carrier arrangement is suited to the large diameter narrow face width planetary gear set since this allows for relatively stiff, short length and large diameter cantilevered planet pins 41. A more conventional double sided planet carrier could, however, be used in other embodiments.

The output from the planetary gear mechanism is through the carrier 43, which necessarily rotates at a reduced rate as compared to the coupling and input shafts 18a and 26. It is splined as at 44 to the output shaft 20 and consequently drives the track drive sprocket 7a. An internal parallel spline set is cut on the carrier 43 and a crowned external spline set is cut on the output shaft 20, thus to accommodate the “float” of the carrier to maximise load sharing between the planet gears.

In an alternative embodiment the planet carrier could be fast with the output shaft and the sun gear allowed to float. This may be preferred when a brake is not associated with the final drive assembly.

In the illustrated embodiment, however, the brake 5a (not shown in FIG. 3) is mounted from the rear of the casing 23 and acts on an inboard extension 26D of the input shaft 26, consequently braking the track drive sprocket 7a via the planetary gear mechanism and output shaft 20. It is preferably a self-energising, liquid-cooled brake according to WO-2007/107771 and WO-2008/047072. It enables the vehicle to remain braked notwithstanding any withdrawal of the shaft 18a from the central assembly A1 as described above.

While in the crowned splined couplings 32 and 44 between the coupling member 31 and input shaft 26 and between the planet carrier 43 and output shaft 20 the crowned splines have been indicated as the external spline set in each case, it could alternatively be the internal spline set that is crowned in either case, or indeed both spline sets could be crowned in either coupling. Equally at least the coupling 44 between the planet carrier 43 and output shaft 20 could be modified so that the external spline set is provided on the planet carrier and the internal spline set is provided on the output shaft instead of vice versa.

What is claimed is:

1. A final drive assembly comprising a planetary gear reduction mechanism of which the input is through the sun gear and the output is through the planet carrier, the sun gear turning with a first, hollow shaft which is driven through a second shaft extending coaxially within the first shaft, and the first and second shafts being coupled through a coupling member splined to each said shaft.

2. An assembly according to claim 1 wherein the coupling member and first shaft are coupled through a crowned spline coupling having a diameter substantially greater that the splined coupling between the coupling member and second shaft.

3. An assembly according to claim 1 comprising a mechanism for displacing the second shaft axially with respect to the first shaft while the splined couplings of the coupling member to each said shaft are maintained.

4. An assembly according to claim 1 wherein the first shaft is rotationally supported by bearings located outboard of the sun gear in the sense of the intended mounting of the assembly to a vehicle.

5. An assembly according to claim 1 wherein the first shaft is rotationally supported by bearings acting between the first shaft and a third shaft which is arranged to be driven by the planet carrier.

6. An assembly according to claim 1 wherein the assembly of planet carrier and planet gears floats between the sun gear and annulus of the planetary gear reduction mechanism.

7. An assembly according to claim 1 wherein the planet carrier is single sided and supports the planet gears in cantilever fashion.

8. An assembly according to 1 claim wherein the output from the planet carrier is through a crowned spline coupling.

9. An assembly according to claim 1 in combination with a track drive sprocket for a tracked vehicle arranged to be driven through said assembly.

10. An assembly according to claim 1 in combination with a brake arranged to act on the first shaft.

11. A drive configuration for a skid steered vehicle comprising: a pair of propulsion motors coupled through respective transmissions to drive a respective drive member at a respective side of the vehicle; at least one steer motor coupled to a differential gear mechanism coupled between said propulsion motors to selectively impose a speed difference between said drive members; and each transmission comprising a respective final drive assembly according to claim 1 associated with the respective drive member.

12. A vehicle equipped with one or more final drive assemblies according to claim 1.

13. A vehicle equipped with a drive configuration according to claim 11.
